(19) United States
(12) Patent Application Publication
(10) Pub. No.: US 2018/0095549 A1
(43) Pub. Date: Apr. 5, 2018

(54) DETECTION METHOD AND DETECTION APPARATUS FOR DETECTING THREE-DIMENSIONAL POSITION OF OBJECT

(71) Applicant: FANUC CORPORATION, Yamanashi (JP)

(72) Inventors: Atsushi WATANABE, Yamanashi (JP); Yuuki TAKAHASHI, Yamanashi (JP)

(21) Appl. No.: 15/712,193

(22) Filed: Sep. 22, 2017

(30) Foreign Application Priority Data
Sep. 30, 2016 (JP) 2016-194105

(51) Int. Cl. G06F 3/03; G01B 11/00; G06F 3/0346

(52) U.S. Cl. CPC G06F 3/0325; G06K 9/2036; G06F 3/0346; G01B 11/005

(57) ABSTRACT

A detection apparatus for detecting a three-dimensional position of an object includes a feature point detecting unit that, with consecutive or at least alternately consecutive two images among multiple images sequentially imaged when a robot is moving being a first image and a second image, detects multiple feature points in the second image including one feature point detected in the first image; a distance calculating unit that calculates a distance between the one feature point of the first image and the multiple feature points of the second image; and a feature point determining unit that determines a feature point for which the distance is the shortest. With consecutive or at least alternately consecutive next two images being the first image and the second image, processing for determining a feature point for which the distance is the shortest is repeated, thereby tracking the feature points of the object.

### BACKGROUND OF THE INVENTION

### 1. Field of the Invention

The present invention relates to a detection method for detecting a three-dimensional position of an object in a system including a robot, and an imaging unit supported adjacent to a distal end of the robot, and a detection apparatus for implementing such a detection method.

### 2. Description of Related Art

In order to accurately perform an operation such as conveying or processing a workpiece using a robot, it is needed to accurately recognize the position where the workpiece is placed. As such, in recent years, it has been the practice to visually recognize the position of the workpiece, in particular, the three-dimensional position of the workpiece using a camera or the like.

In Japanese Registered Patent No. 3859371, Japanese Unexamined Patent Publication (Kokai) No. 2012-192473, and Japanese Unexamined Patent Publication (Kokai) No. 2004-90183, it is disclosed to determine a three-dimensional position of a workpiece or the like with cameras. Furthermore, in Japanese Unexamined Patent Publications (Kokai) Nos. 2014-34075 and 2009-241247, it is disclosed to determine a three-dimensional position of a workpiece or the like using a camera including lenses.

### SUMMARY OF INVENTION

However, in the above-described conventional techniques, there is a problem that because multiple cameras or multiple lenses are used, the structure becomes complicated and the cost is increased accordingly.

Further, in a stereo camera, the processing cost to associate a stereo pair of images is the most expensive. When the quality of the association of the stereo-pair of images is low, the reliability of the stereo camera is also decreased.

The present invention has been made in view of the above circumstances, and it is an object of the invention to provide a detection method for detecting a three-dimensional position of an object, wherein the reliability is enhanced while the cost is reduced, without using the multiple cameras or multiple lenses, and a detection apparatus for carrying out such a method.

In order to achieve the above object, according to a first aspect of the present invention, a detection method is provided for detecting a three-dimensional position of an object including one or more feature points in a system including a robot, and an imaging unit which is supported adjacent to a distal end of the robot, the detection method including steps of: imaging sequentially images of the object by the imaging unit when the robot is moving; with consecutive or at least alternately consecutive two images among the multiple images being set as a first image and a second image, detecting feature points in the second image including one feature point detected in the first image; calculating each distance between the one feature point in the first image and the feature points in the second image; determining a feature point for which the distance is the shortest; and repeating processing for determining the feature point for which the distance is the shortest, with consecutive or at least alternately consecutive next two images among the multiple images being set as the first image and the second image, thereby tracking the one feature point of the object.

These objects, features and advantages, as well as other objects, features, and advantages, of the present invention will become more apparent from a detailed description of embodiments of the present invention illustrated in the accompanying drawings.

### BRIEF DESCRIPTION OF THE DRAWINGS

FIG. 1 is a schematic view of a system including a detection apparatus based on the present invention.

FIG. 2 is a flowchart illustrating the operation of the detection apparatus illustrated in FIG. 1.

FIG. 3 is another flowchart illustrating the operation of the detection apparatus illustrated in FIG. 1.

FIG. 4 is a view illustrating a robot and images.

FIG. 5 is a view illustrating a first image and a second image.

FIG. 6A is another view illustrating a robot and images.

FIG. 6B is still another view illustrating a robot and images.

### DETAILED DESCRIPTION

Embodiments of the present invention will be described with reference to the accompanying drawings. Throughout the drawings, like reference numerals are assigned to like members. The scale of the drawings is appropriately altered in order to facilitate understanding.

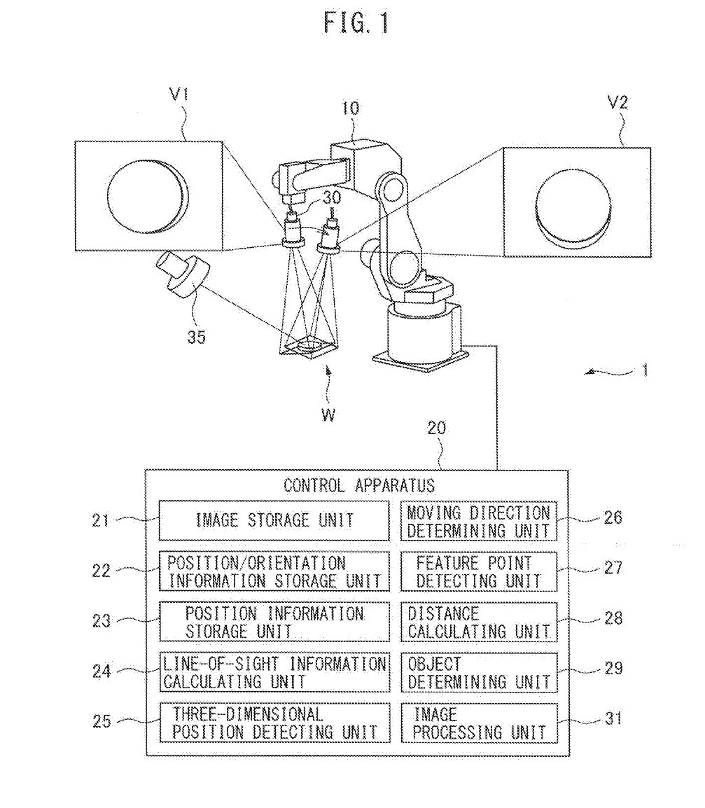

FIG. 1 is a schematic view of a system including a detection apparatus based on the present invention. As illustrated in FIG. 1, the system 1 includes a robot 10, and a control apparatus 20 that controls the robot 10. The control apparatus 20 also serves as a detection apparatus that detects a three-dimensional position of an object. While the robot 10 illustrated in FIG. 1 is a vertically articulated robot, any other type of robot may be employed. Further, a camera 30 is supported at or adjacent to a distal end of the robot 10. A position/orientation of the camera 30 is determined depending on the robot 10. Any other type of imaging unit may be used instead of the camera 30.

In addition, in FIG. 1, a projector 35 is illustrated which is configured to project a spotlight onto an object W such as workpiece. The camera 30 can acquire an image having a clear spotlight point as a feature point using the projector 35. Thus, an image processing unit 31, which will be described hereinafter, can satisfactorily perform image processing of an imaged image. It may be configured such that the position/orientation of the projector 35 is controlled by the control apparatus 20. Meanwhile, the projector 35 may be mounted on the robot 10.

The control apparatus 20, which may be a digital computer, controls the robot 10, and serves as a detection apparatus that detects a three-dimensional position of the object W. As illustrated in FIG. 1, the control apparatus 20 includes an image storage unit 21 that stores images of the object W, which are imaged sequentially by the camera 30 when the robot 10 is moving.

In addition, the control apparatus 20 includes a position/orientation information storage unit 22, which, with earlier-stage consecutive two images of the multiple images being set as a first image and a second image, stores first position/orientation information of the robot when the first image is imaged and which, with later-stage two images of the multiple images being set as a first image and a second image, stores second position/orientation information of the robot when the second image is imaged. Further, the control apparatus 20 includes a position information storage unit 23 that stores first position information in an imaging unit coordinate system of one feature point detected in the first image of the consecutive two images of the multiple images, and stores second position information in the imaging unit coordinate system of the one feature point detected in the second image of the last two images. Further, the control apparatus 20 includes an image processing unit 31 that processes the first image and the second image and detects a feature point.

Further, the control apparatus 20 includes a line-of-sight information calculating unit 24 that calculates first line-of-sight information of the one feature point in a robot coordinate system using the first position/orientation information of the robot and the first position information of the one feature point and calculates second line-of-sight information of the feature point in the robot coordinate system using the second position/orientation information of the robot and the second position information of the one feature point of a second image, and a three-dimensional position detecting unit 25 that detects a three-dimensional position of the object based on an intersection point of the first line-of-sight information and the second line-of-sight information.

The line-of-sight information calculating unit 24 may calculate first line-of-sight information and second line-of-sight information of at least three feature points. Further, the three-dimensional position detecting unit 25 may detect a three-dimensional position of each of the at least three feature points based on the intersection point of the calculated first line-of-sight information and second line-of-sight information, thereby detecting a three-dimensional position/orientation of a workpiece including the at least three feature points.

Further, the control apparatus 20 includes: a moving direction determining unit 26 that determines the moving direction in which the camera 30 moves via movement of the robot 10; a feature point detecting unit 27 that, with consecutive two images of multiple images imaged sequentially by the imaging unit when the robot is moving being set as a first image and a second image, detects one feature point detected in the first image and feature points in the second image including the one feature point detected in the first image; a distance calculating unit 28 that calculates each distance between the one feature point in the first image and the feature points in the second image; and an feature point determination unit 29 that determines a feature point for which the above distance is the shortest.

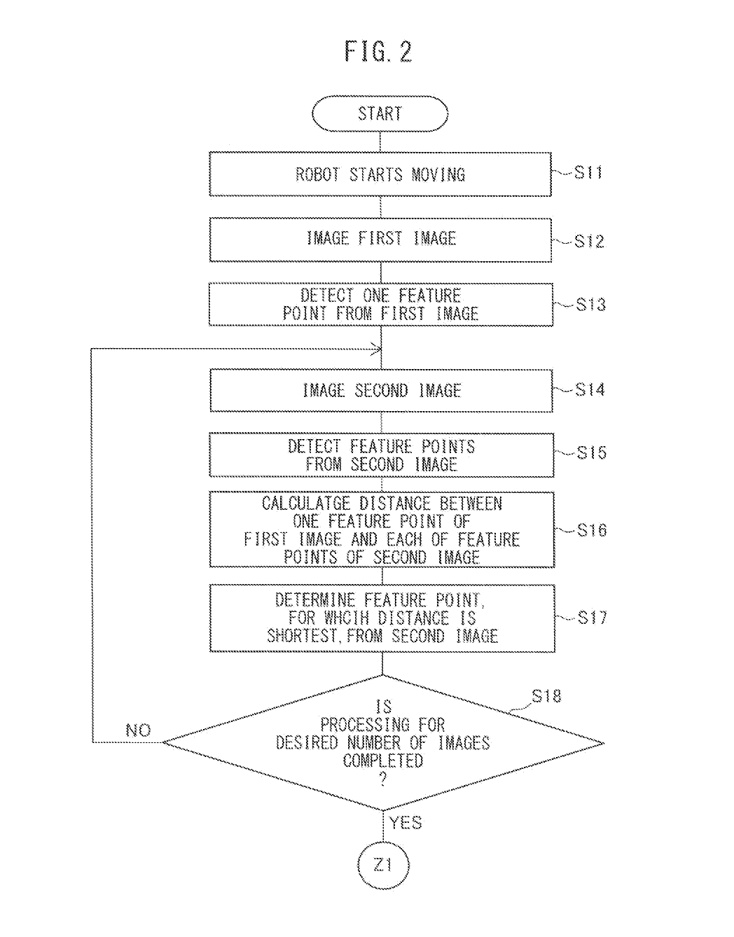

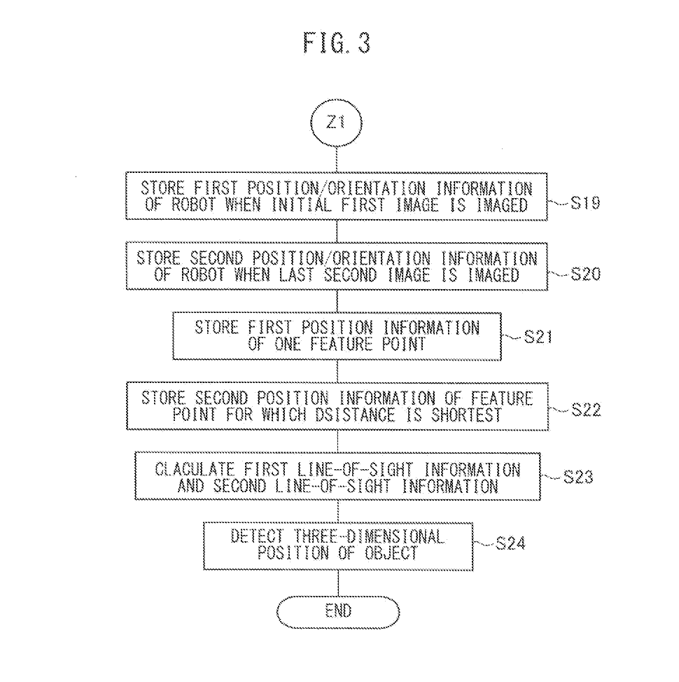

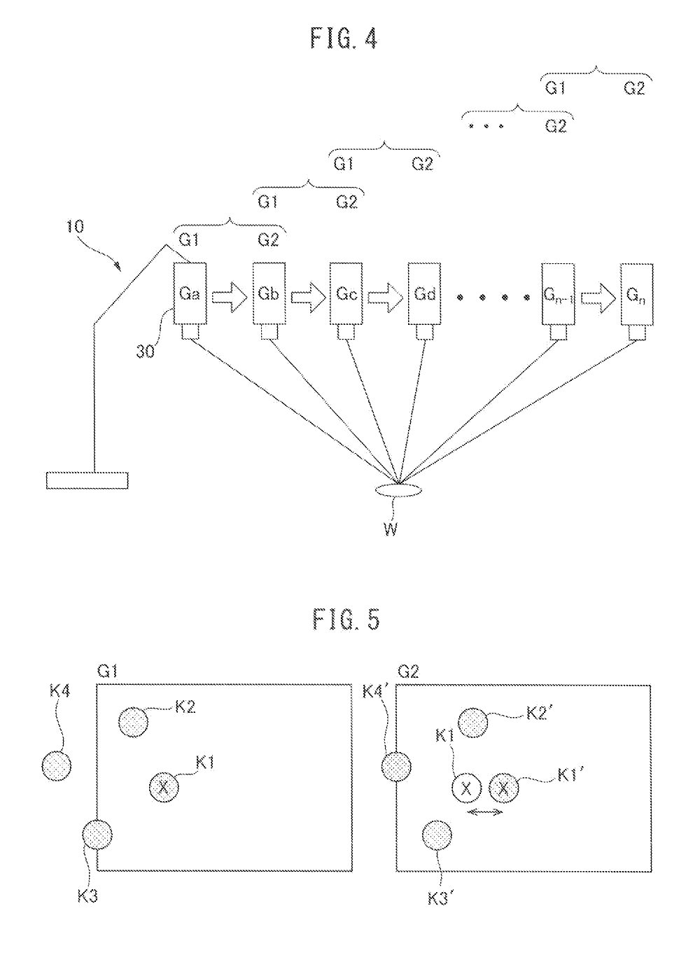

FIGS. 2 and 3 are flowcharts illustrating the operation of the detection apparatus illustrated in FIG. 1, and FIG. 4 is a view illustrating a robot and images. Referring to FIGS. 2 to 4, description will now be made of the operation of the detection apparatus based on the present invention. The object W placed in a predetermined position includes feature points such as the center of an opening of a workpiece, and a corner portion of the workpiece.

At step S11, the robot 10 starts movement as illustrated in FIG. 4. At step S12, the camera 30 equipped on the robot 10 images an image Ga of the object W. The image Ga is stored in the image storage unit 21 and set as a first image G1.

As will be appreciated from reference to FIG. 4, it is configured such that the camera 30 equipped on the robot 10 sequentially images multiple images Ga to Gn (n is a natural number) of the object W. In FIG. 4, these images Ga to Gn are displayed in the camera 30 corresponding to a movement position of the robot.

Subsequently, at step S13, the feature point detecting unit 27 detects one feature point from the first image G1. When feature points are detected from the first image G1, an arbitrary feature point, for example, a feature point located at the center of the image may be set as the one feature point described above.

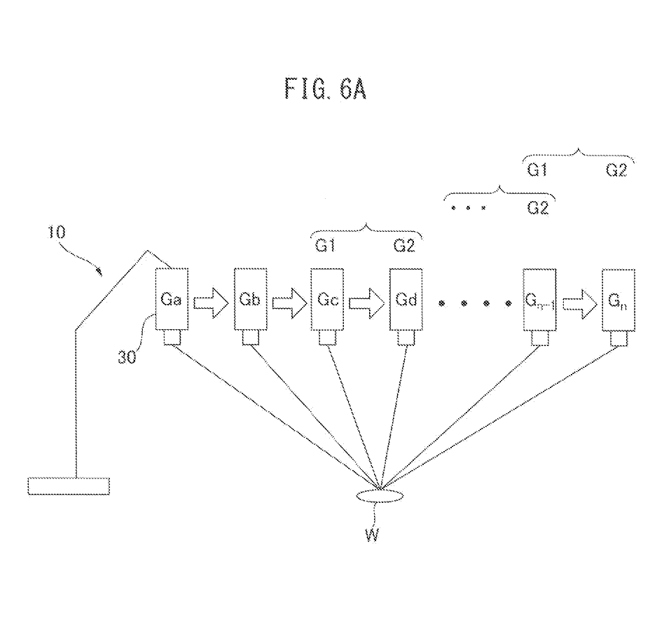

FIG. 5 illustrates the first image and the second image. In the first image G1 illustrated in FIG. 5, feature points K1 to K3 represented by filled circles are indicated. In FIG. 5, the feature point K1 located relatively at the center of the first image G1 is set as the one feature point described above.

Subsequently, at step S14, the camera 30 equipped on the robot 10 which continues moving images an image Gb of the object W. The image Gb is stored in the image storage unit 21 and set as the second image G2. In other words, consecutive two images Ga and Gb are set as the first image G1 and the second image G2.

Subsequently, at step S15, the feature point detecting unit 27 detects feature points from the second image G2. It is needed that the feature points of the second image G2 detected by the feature point detection unit 27 include the one feature point of the first image G1 described above.

The second image G2 of FIG. 5 displays feature points K1′ and K2′ corresponding to the feature points K1 and K2 of the first image G1 and other feature points K3′ and K4′ which are not included in the first image G1. Further, in the second image G2, the feature point K1 is indicated at a position corresponding to the feature point K1 of the first image G1.

Subsequently, at step S16, the distance calculation unit 28 calculates a distance between the position of the one feature point in the first image G1 and the position of each of the multiple feature points in the second image G2. In other words, the distance calculation unit 28 calculates a distance between the feature point K1 indicated in FIG. 5 and each of the feature points K1′ to K3′.

Subsequently, at step S17, the feature point determination unit 29 determines a feature point for which the distance is the smallest. In FIG. 5, it will be appreciated that the distance between the feature point K1 and feature point K1′ is the shortest. Consequently, the feature point determination unit 29 determines the feature point K1′ to be a feature point for which the distance is the shortest. In such a case, even when the robot 10 moves at a high speed, it is possible to determine the three-dimensional position of the object, while facilitating association of the images.

Thereafter, at step S18, it is determined whether the above-described processing has been performed with respect to a desired number of images. In this case, since the above-described processing has not been performed with respect to the desired image, the feature point K1′ of the second image G2 is stored as the one feature point K1 of the first image, and the routine returns to step S14. Alternatively, it may be such that the second image is substituted for the first image, the feature point K1′ is stored as the feature point K1, and the routine returns to step S14. The desired number is preferably 2 or more. In the following, the next consecutive image Gc of the multiple images illustrated in FIG. 4 is set as the second image G2, and the above-described processing is repeated.

Let it be assumed that such processing is repeated until all of the desired number of images have been processed. In this manner, the feature point K is tracked through the images Ga to Gn. Since the position of the feature point K in the object W is known, the object W can be tracked. In an embodiment which is not illustrated in the drawings, the above-described processing may be performed after a desired number of images are imaged when the robot 10 moves.

In FIG. 4, the images Ga to Gn are set in order from a first pair of images as the first image G1 and the second image G2. However, the first image G1 and the second image G2 may be set differently from the manner illustrated in FIG. 4.

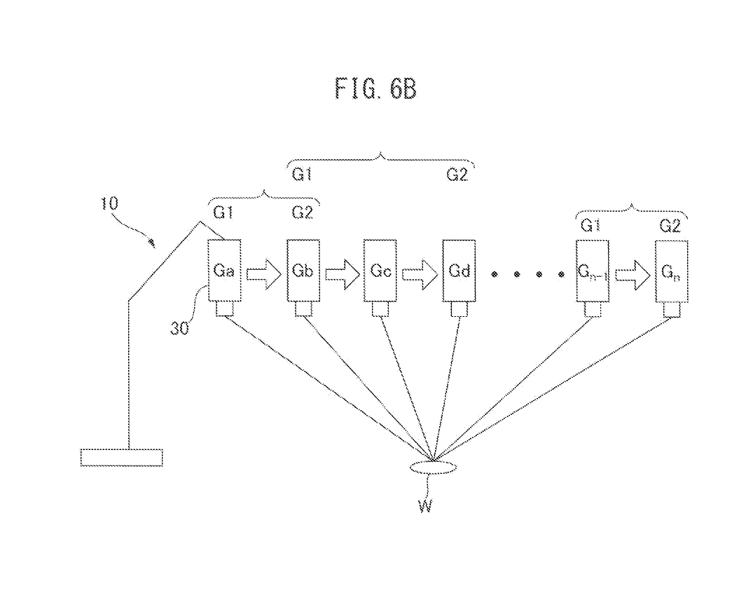

FIG. 6A is another view illustrating a robot and multiple images. In FIG. 6A, the Images Gc and Gd are set as the first image G1 and the second image G2 in the first processing of steps S12 to S17. In other words, it is not always needed to use the images Ga and Gb. Likewise, it is not always needed to use the last consecutive images Gn-1 and Gn, and for example, images Gn-3 and Gn-2 may be used as the last consecutive images.

In FIG. 6B, the two consecutive images Ga and Gb are set as the first image G1 and the second image G2 in the first processing. Further, in the second processing, the two images Gb and Gd are set. The image Gc is not used. In this manner, as will be appreciated, a part of the multiple images may be omitted, and, in such a case, two alternately consecutive images may be used, whereby the processing time may be reduced.

Hereinafter, description will continue on the assumption that the first image G1 and the second image G2 have been set as referenced to FIG. 4. Referring to FIG. 3, at step S19, first position/orientation information PR1 of the robot 10 when the first image G1 out of the first two images Ga and Gb among the multiple images, i.e., the image Ga is imaged is stored in the position/orientation information storage unit 22.

Subsequently, at step S20, second position/orientation information PR2 of the robot 10 when the second image G2 out of the last two images G(n-1) and Gn among the multiple images, i.e. the image Gn is imaged is stored in the position/orientation information storage unit 22. Since the robot 10 is moving as described above, the second position/orientation information PR2 and the first position/orientation information PR1 are different from each other.

Subsequently, at step S21, first position information PW1 of the above-described one feature point K1 in the first image G1 of the first two images Ga and Gb among the multiple images, i.e. the image Ga is stored in the position information storage unit 23. Then, at step S22, second position information PW2 of the feature point K1′, for which the above-described distance is the shortest, of the second image G2 of the last two images G (n-1) and Gn among the multiple images, i.e. the image Gn is stored in the position information storage unit 23.

Subsequently, at step S23, the line-of-sight information calculating unit 24 calculates firs line-of-sight information L1 based on the first position/orientation information PR1 and the first position information PW1. Likewise, the line-of-sight information calculating unit 24 calculates second line-of-sight information L2 based on the second position/orientation information PR2 and the second position information PW2 . As can be seen from FIG. 4, the first and second pieces of line-of-sight information L1 and L2 are lines of sight extending from the camera 30 to the object W, respectively. The first and second pieces of line-of-sight information L1 and L2 are indicated by a cross in the first image G1 and the second image G2 in FIG. 5.

Subsequently, at step S24, the three-dimensional position detecting unit 25 detects a three-dimensional position of the object W from an intersection point or an approximate intersection point of the first and second pieces of line-of-sight information L1 and L2. As above, according to the present invention, since feature points are tracked using multiple images which are consecutively imaged while moving the robot 10, it is possible to detect a three-dimensional position of the object W without associating two feature points detected using multiple camera or multiple lenses as in the prior art. Therefore, according to the present invention, it is possible to reduce the cost, while simplifying the configuration of the entire system 1.

In other words, features points of the object in the first image G1 and the second image G2 can positively be associated as at stereo pair by tracking one feature point while the robot 10 is moving.

In the present invention, since association is made based on tracking of feature points, even when the robot 10 moves at a high speed, association of images is consecutively and sequentially performed, so that there is no need to detect and associate each feature point of the object in the first image G1 and the second image G2 after the movement of the robot 10 is completed. Further, since the association of stereo pairs is easy and reliable, the reliability can be improved as compared with the prior art.

Meanwhile, among workpieces including multiple feature points, there is a workpiece whose three-dimensional position/orientation is determined using the three-dimensional positions of at least three feature points. When the three-dimensional position/orientation of such a workpiece is determined, at first, the feature point detecting unit 27 detects, in the second image G2, at least three feature points located in the first image G1. Hereafter, as in the above, three feature points can be tracked and detected in multiple images which are consecutively imaged.

Then, the line-of-sight information calculating unit 24 calculates the first line-of-sight information and the second line-of-sight information of at least three feature points. Further, the three-dimensional position detecting unit 25 detects a three-dimensional position of each of at least three feature points from each intersection point of the calculated first and second pieces of line-of-sight information. In this manner, the three-dimensional position detecting unit 25 can detect the three-dimensional position/orientation of the workpiece.

### Aspects of the Disclosure

In order to achieve the above object, according to a first disclosure, a detection method, is provided for detecting a three-dimensional position of an object including one or more feature points in a system including a robot, and an imaging unit which is supported adjacent to a distal end of the robot, the detection method including steps of: imaging sequentially multiple images of the object by the imaging unit when the robot is moving; with consecutive or at least alternately consecutive two images among the multiple images being set as first image and a second image, detecting multiple feature points in the second image including one feature point detected in the first image; calculating each distance between the one feature point in the first image and the multiple feature points in the second image; determining a feature point for which the distance is the shortest; and repeating processing for determining the feature point for which the distance is the shortest, with consecutive or at least alternately consecutive next two images among the multiple images being set as the first image and the second image, thereby tracking the one feature one of the object.

According to a second disclosure, the defection method according to the first disclosure further includes steps of; storing first position/orientation information of the robot when the first image of earlier-stage two images among the multiple images in which the feature points are detected is imaged; storing second position/orientation information of the robot when the second image of later-stage two images among the multiple images is imaged; storing first position information in an imaging unit coordinate system of the one feature point detected in the first image; storing second position information in the imaging unit coordinate system of the feature points defected in the second image; calculating first line-of-sight information of the one feature point in a robot coordinate system using the first position/orientation information of the robot and the first position information of the one feature point, calculating second line-of-sight information of the feature points in the robot coordinate system using the second position/orientation information of the robot and the second position information of the feature points; and detecting a three-dimensional position of the object from an intersection point of the first line-of-sight information and second line-of-sight information.

According to a third disclosure, the detection method according to the second disclosure further comprising the step of projecting a spotlight onto the object, thereby facilitating detecting the feature points.

According to a fourth disclosure, the detecting method according to the second disclosure, wherein the object includes at least three feature points, further comprising: detecting, in the second image, at least three feature points located in the first image; calculating the first-line of sight information and the second line-of-sight information of the at least three feature points respectively; and detecting each three-dimensional position of the at least three feature points from each intersection point of the calculated first and second pieces of line-of-sight information, thereby detecting a three-dimensional position/orientation of the object including the at least three feature points.

According to a fifth disclosure, a detection apparatus is provided for detecting a three-dimensional position of an object including one or more feature points in a system including a robot, and an imaging unit which is supported adjacent to a distal end of the robot, the detection apparatus comprising: a feature point detecting unit that, with consecutive or at least alternately consecutive two images among multiple images of the object sequentially imaged by the imaging unit when the robot is moving being set as a first image and a second image, detects multiple feature points in the second image including one feature point detected in the first image; a distance calculating unit that calculates each distance between the one feature point in the first image and the multiple feature points in the second image; and a feature point determining unit that determines a feature point for which the distance is the shortest, wherein with consecutive or at least alternately consecutive next two images among the multiple images being set as the first image and the second image, processing for determining the feature point for which the distance is the shortest is repeated, thereby tracking the one feature point of the object.

According to a sixth disclosure, the detection apparatus according to the fifth disclosure further comprising: an image storage unit that stores multiple images of the object sequentially imaged by the imaging unit when the robot is moving; an orientation information storage unit that stores first position/orientation information of the robot when the first image of earlier-stage two images among the multiple images in which the feature points are detected is imaged, and stores second position/orientation information of the robot when the second image of later-stage two images among the multiple images is imaged; a position information storage unit that stores first position information in an imaging unit coordinate system of the one feature point detected in the first image, and stores second position information in the imaging unit coordinate system of the feature points detected in the second image; a line-of-sight information calculating unit that calculates first line-of-sight information of the one feature point in a robot coordinate system using the first position/orientation information of the robot and the first position information of the one feature point, and calculates second line-of-sight information of the one feature point in the robot coordinate system using the second position/orientation information of the robot and the second position information of the one feature point; and a three-dimensional position detecting unit that detects a three-dimensional position of the object from an intersection point of the first line-of-sight information and the second line-of-sight information.

According to a seventh disclosure, the detection apparatus according to the sixth disclosure further comprising a projector that projects a spotlight onto theobject.

According to an eighth disclosure, the defection apparatus according to the sixth disclosure, wherein the object includes at least three feature points, further comprises: a feature point detecting unit that detects, in the second image, at least three feature points located in the first image; a line-of-sight information calculating unit that calculates the first line-of-sight information and the second line-of-sight information of the at least three feature points respectively; and a three-dimensional position detecting unit that detects a three-dimensional position of each of the at least three feature points from each intersection point of the calculated first and second pieces of line-of-sight information, thereby detecting a three-dimensional position/orientation of the object including the at least three feature points.

### Advantage of the Disclosure

In the first and fifth disclosures, since the object is tracked using the two images imaged while moving the robot, there is no need to use multiple imaging units or multiple lenses. As a result, the cost can be reduced, while the configuration of the entire system is simplified.

Further, since the one feature point to be associated as a stereo pair in the first image and the second image is set such that the robot moves and images an image over a period in which the distance between the one feature point of the first image and the feature points of the second image becomes the shortest, the one feature point can be positively tracked by the method according to the first disclosure, and thus, it is not needed to perform association after the moving manipulation by the robot. Consequently, for example in a container in which many pacts having the same shape are contained, by tracking a feature point such as a hole of a certain part, it is possible to positively perform association as a stereo pair in the first image at an earlier-stage of the movement and the second image at a later-stage of the movement. Further, since association of stereo pair can be easily and positively performed, it is possible to enhance the reliability as compared with that of the prior art, greatly reduce the time taken to perform association of stereo pair which leads to a large processing burden, and achieve reduction of the cost of the apparatus.

In the second and sixth disclosures, since a feature point for which the distance is the shortest is employed, it is possible to determine a three-dimensional position of the object, while easily performing association of images, even when the robot moves at a high speed.

In the third and seventh disclosures, since an image in which a clear spotlight is a feature point can be acquired, it is possible to satisfactorily perform image processing.

In the fourth and eighth disclosures, it is possible to detect a three-dimensional position/orientation of the object through three-dimensional positions of three feature points possessed by the object.

While the present disclosure has been described using exemplary embodiments, those skilled in the art will be able to understand that the above-described modifications and various other modifications, omissions and additions can be made without departing from the scope of the present disclosure.

1. A detection method for detecting a three-dimensional position of an object including one or more feature points in a system including a robot, and an imaging unit which is supported adjacent to a distal end of the robot, the detection method comprising steps of:
imaging sequentially images of the object by the imaging unit when the robot is moving;
with consecutive or at least alternately consecutive two images among the images being set as a first image and a second image, detecting feature points in the second image including one feature point detected in the first image;
calculating each distance between the one feature point in the first image and the feature points in the second image;
determining a feature point for which the distance is the shortest; and
with consecutive or at least alternately consecutive next two images among the images being set as the first image and the second image, repeating processing for determining the feature point for which the distance is the shortest, thereby tracking the one feature point of the object.

2. The detection method according to claim 1, further comprising steps of:
storing first position/orientation information of the robot when the first image of earlier-stage two images in which the feature points are detected among the images is imaged;
storing second position/orientation information of the robot when the second image of later-stage two images in which the feature points are detected among the images is imaged;
storing first position information in an imaging unit coordinate system of the one feature point detected in the first image;
storing second position information in the imaging unit coordinate system of the one feature point detected in the second image;
calculating first line-of-sight information of the one feature point in a robot coordinate system using the first position/orientation information of the robot and the first position information of the one feature point, and calculating second line-of-sight information of the feature point in the robot coordinate system using the second position/orientation information of the robot and the second position information of the one feature point; and
detecting a three-dimensional position of the object from an intersection point of the first line-of-sight information and the second line-of-sight information.

3. The detection method according to claim 2, wherein a spotlight projected onto the object is a feature point.

4. The detection method according to claim 2, wherein the object includes at least three feature points, the detection method further comprising steps of:
detecting, in the second image, at least three feature points located in the first image;
calculating the first line-of-sight information and the second line-of-sight information of the at least three feature points respectively; and
detecting each three-dimensional position of the at least three feature points from each intersection point of the calculated first and second pieces of line-of-sight information, thereby detecting three-dimensional position/orientation of the object including the at least three feature points.

5. A detection apparatus for detecting a three-dimensional position of an object including one or more feature points in a system including a robot, and an imaging unit which is supported adjacent to a distal end of the robot, the detection apparatus comprising:
a feature point detecting unit that, with consecutive or at least alternately consecutive two images among images of the object sequentially imaged by the imaging unit when the robot is moving being set as a first image and a second image, detects feature points in the second image including one feature point detected in the first image;
a distance calculating unit that calculates each distance between the one feature point in the first image and the feature points in the second image; and
a feature point determining unit that determines a feature point for which the distance is the shortest,
wherein with consecutive or at least alternately consecutive next two images among the images being set at the first image and the second image, processing for determining the feature point for which the distance is the shortest is repeated, thereby tracking the one feature point of the object.

6. The detection apparatus according to claim 5, further comprising:
an image storage unit that stores images of the object sequentially imaged by the imaging unit while the robot is moving;
a position/orientation information storage unit that stores first position/orientation information of the robot when a first image of earlier-stage two images in which feature points are detected among the images is imaged, and stores second position/orientation information of the robot when a second image of later-stage two images in which feature points are detected among the images is imaged;
a position information storage unit that stores first position information in an imaging unit coordinate system of the one feature point detected in the first image, and stores second position information in the imaging unit coordinate system of the one feature point detected in the second image;
a line-of-sight information calculating unit that calculates first line-of-sight information of the one feature point in a robot coordinate system using the first position/orientation information of the robot and the first position information of the one feature point, and calculates second line-of-sight information of the one feature point in the robot coordinate system using the second position/orientation information of the robot and the second position information of the one feature point; and
a three-dimensional position detecting unit that detects a three-dimensional position of the object from an intersection point of the first line-of-sight information and the second line-of-sight information.

7. The detection apparatus according to claim 6, further comprising:
a projector configured such that a spotlight projected onto the object is a feature point.

8. The detection apparatus according to claim 6, wherein the object includes at least three feature points, the detection apparatus further comprising;
a feature point detecting unit that detects, in the second image, at least three feature points located in the first image;
a line-of-sight information calculating unit that calculates the first line-of-sight information and the second line-of-sight information of the at least three feature points respectively; and
a three-dimensional position detecting unit that detects each three-dimensional position of the at least three feature points from each intersection point of the calculated first and second pieces of line-of-sight line information, thereby detecting a three-dimensional position/orientation of the object including the at least three feature points.
